(19) United States
(12) Patent Application Publication
(10) Pub. No.: US 2022/0041152 A1
(43) Pub. Date: Feb. 10, 2022

(54) Automatic Vehicle Air Brake Pushrod Stroke Measuring System

(71) Applicant: Brian Hearing, Falls Church, VA (US)

(72) Inventor: Brian Hearing, Falls Church, VA (US)

(21) Appl. No.: 16/987,072

(22) Filed: Aug. 6, 2020

(51) Int. Cl. B60T 17/22

(52) U.S. Cl. CPC B60T 17/22

(57) ABSTRACT

A system, method, and apparatus for vehicle brake monitoring are disclosed. An example method includes receiving three dimensional imagery of a vehicle brake and recording, via a digital interface card, the imagery with and without the brake applied. The method also includes processing, via a processor, the digital imagery samples into a real-world distance measurement of brake components with and without the brake applied. The method further includes applying, via the processor, feature matching to compare the brake component travel distance with at least one measurement recorded previously and stored in a database. The method moreover includes, conditioned on significant changes from that previously recorded measurements, transmitting via the processor, an alert that problems may exist with the sampled vehicle brake.

### FIELD OF THE INVENTION

The invention relates to the process of automatically monitoring air brake pushrod stroke length to evaluate the condition of the vehicle's brake actuators.

### BACKGROUND OF THE INVENTION

Despite advances in vehicle safety technology vehicle brakes remain a common cause of accidents and mechanical breakdowns. Fatal tractor trailer accidents cost Americans more than $20 billion every year and one person is killed or injured in a truck accident every 16 minutes. According to a recent study by the United States Department of Transportation (DOT) almost 30% of all commercial truck accidents involve brake failure and roadside inspections fail on average 15% of all trucks and buses randomly inspected due to brake-related violations.

Among brake problems, air brake chambers that have pushrod travel beyond regulation limits are the most common forms of violations found by law enforcement (often called “out of adjustment”). Out-of-adjustment brakes and brake-system violations represented 45 percent of all out-of-service vehicle violations issued during a recent law enforcement campaign. Air brakes use a variety of mechanisms to transform air pressure to braking actuation, with clamp-style air brake chambers being one of the most common. Air brake chambers use air pressure to move a pushrod that then actuates pressure from the brake friction surface to the drum. If the travel of the pushrod is too far the brake may not apply needed friction and is considered a violation by vehicle inspection personnel.

Current maintenance procedures call for periodic scheduled inspections but vehicle brakes are inherently difficult to fully inspect since many critical components face each other (usually with only millimeter-sized gaps) and are not visible without invasive and costly manual inspection. Because of this, current maintenance and inspection approaches to vehicle brake stroke inspection are often limited to manual measurement of pushrod travel and there exists a need for a low-cost, high-speed capability for maintenance and inspection personnel to detect brake pushrod travel length more efficiently.

A number of prior patents have proposed various methods and apparatus to monitor the push rod movement during actuation of the brake and provide some indication to an operator as to when there is excessive push rod movement, which is referred to as “overstroke.” For example, the push rod of a typical brake actuator may include a brightly colored ring, which may be painted on the push rod, indicating an overstroke condition when the ring extends out of the brake actuator during actuation of the brakes. The ring may, however, be difficult to see because of the location of the brake actuators beneath the truck or trailer and accumulated road debris.

Electronic brake monitoring systems have also been proposed, for example U.S. Pat. Nos. 6,255,941; 6,352,137; 6,417,768; 6,480,107; 6,891,468; 8,319,623; 8,994,523; 6,480,107; 6,753,771; 6,888,451; 9,440,633; and 9,873,419. These systems are located on the vehicle but require a costly retrofit or incorporation on each brake chamber and cannot be used for independent verification by enforcement personnel. Furthermore, the brake actuators are mounted beneath the vehicle and are subjected to hostile environment that can damage the monitoring system, particularly where there are exposed pistons, sleeves, sensors, and related devices.

The prior art has also proposed various methods and apparatus using computer vision for mechanical inspection. For example US2005/0226489 and U.S. Pat. No. 10,062,411 use computer vision for preventative maintenance of machinery, but the disclosed systems focus on monitoring industrial processes and machinery, such as in product quality on an assembly line. The inventor is aware of no prior art directed towards using computer-based visual detection systems to automate the process of vehicle brake inspection.

### SUMMARY OF THE INVENTION

The present disclosure provides a new and innovative system, method, and apparatus to automatically measure vehicle brake pushrod stroke. The system, method, and apparatus use computer-based visual detection (“computer vision”) to observe and evaluate vehicle brake pushrod stroke distances against an acceptable reference standard. The use of computer vision enables an automated and independent evaluation of pushrod stroke from a distance off the vehicle, without manual inspection, and without the need for connections to on-board vehicle sensors.

In an exemplary embodiment, a vehicle brake stroke image monitoring device is placed on or in the ground in the travel path of a braking vehicle. An imaging sensor records a first set of images of the brake system while the brake is applied during a vehicle stop and then a second set of images when the brake is released in position above the image sensors. A programmed processor within the device analyzes the images to detect the positions of the brake stroke pushrod as the brake is engaged and disengaged. The processor uses camera calibration data and object depth information to calculate the real-world travel distance of the pushrod. The processor transmits the resulting information to a remote user interface where alerts are issued to the interface if the detected stroke travel is beyond an allowable distance.

Additional features and advantages of the disclosed system, method, and apparatus are described in, and will be apparent from, the following Detailed Description and the Figures.

### BRIEF DESCRIPTION OF THE DRAWINGS

FIG. 1 shows sensors located under a vehicle able to take three dimensional measurements of the undercarriage, including brakes.

FIG. 2 shows an example of overlaid images of brake components with the brake engaged and released, with computer identified feature change also illustrated.

FIG. 3 shows an example vehicle brake stroke monitoring environment including a sample processor and a management server, according to an example embodiment of the present disclosure.

FIG. 4 shows a diagram of the sample processor of FIG. 3, according to an example embodiment of the present disclosure.

FIG. 5 illustrates a flow diagram showing an example procedure to create measurements of brake stroke travel observed between images while the brake is applied and disengaged, according to an example embodiment of the present disclosure.

FIG. 6 shows a detailed block diagram of an example of an imagery processor, user device and/or management server, according to an example embodiment of the present disclosure.

### DETAILED DESCRIPTION OF THE INVENTION

Recent developments in low-cost three dimensional imaging sensors (depth cameras, LIDAR, etc.) and pervasive networking now enable truck fleet owners, service stations, taxi companies, and similar vehicle service facilities to have the ability to automatically measure and monitor brake pushrod stroke distances for vehicles under their responsibility. Such automatic analysis provides a cost effective way to monitor and inspect brake systems easily and more frequently with the attendant benefit of enhancing vehicle safety.

The vehicle brake stroke monitoring device of the invention is configured to sense, analyze, and evaluate vehicle brake stroke extension distances. The example vehicle brake stroke monitoring device is also configured to transmit an alert conditioned upon evaluating unsafe braking conditions of the vehicle under inspection. The vehicle brake monitoring device may include a self-contained apparatus that may be positioned at any location under the vehicle with line of sight to the brake chambers. The vehicle brake monitoring device may include an exterior casing that is constructed from metal, hard plastic, soft plastic, and/or a combination thereof. In some instances, the vehicle brake monitoring device may be water-tight to enable deployment out-doors.

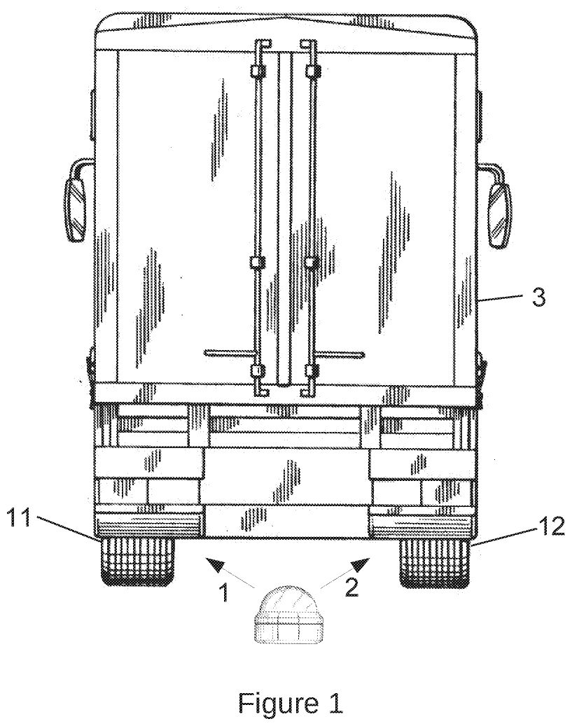

The present disclosure describes a system having three dimensional imaging sensors 1, 2 that are placed or located underneath vehicle 3 to be evaluated, as illustrated in FIG. 1. As shown, imaging sensors 1, 2 are shown beneath the rear of vehicle 3. It will be understood that additional imaging sensors (not shown) can be used to capture images of braking systems associated with the vehicle front wheels and generate suitably tagged images that correlate with such brake locations.

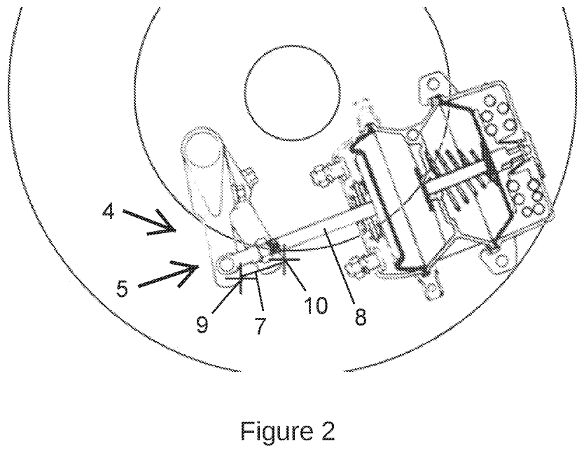

Imaging sensors 1, 2 capture a series of digital images of the vehicle components within their respective fields of view as the vehicle rolls over imaging sensors 1, 2 and applies its brakes to come to a stop. Three dimensional images 4 are made of the brake system 5, illustrated in FIG. 2, from times before and then after the application of the brake. These images are then compared and used to measure distance 7 that the brake pushrod 8 travels from a first rest position 9 (no braking) to a second position 10 during application of brake system 5. If distance 7 exceeds an allowable value for vehicle 3 with brake system 5, an alert is generated by audible and/or visual methods that warns personnel of a brake system that is out of allowable specifications and directs personnel to inspect either or both of left brake 11 and right brake 12 in brake system 5.

Brake distance measurements are preferably stored in a database starting with a reference measurement correlating to a new or properly adjusted brake pushrod distance. Subsequent measurements over time as the vehicle is operated are then stored in a database that correlates such information with specific vehicle 3 or the same model of vehicle, the time, date, and mileage of the vehicle for each such subsequent reading. The progression of the pushrod travel distance 7 as recorded in the database entries is then used to monitor and predict the useful lifetime of the brake friction surface and other components of braking system 5.

The brake stroke measurements can be used to identify vehicles that may need servicing in both drum and disc brakes. Differences in pushrod strokes of different brakes on the same vehicle may be used to identify braking imbalances such as tractor versus trailer, front versus rear, and driver versus passenger sides. Labelled output imaging data is appropriately tagged within the system to enter the appropriate brake location information into the appropriate fields within the central database of the system.

Three Dimensional Imagery Sensor: A preferred vehicle brake stroke monitoring system according to the invention includes at least one and optionally ten or more three-dimensional (3D) imaging sensors having a digital interface. Typically, no more than 2-4 will likely be deemed desirable unless additional sensors are desired for imaging and tracking the condition of other components on the examined vehicle.

For the present invention, the imaging sensors capture a series of digital images of one or more designated brakes from the underside of an examined vehicle. The 3D sensor may include, for example, a depth camera such as stereoscopic video or still camera that delivers images that can be used to calculate a spatial map of the brake components as well as still images. In other embodiments, the sensor could include a scanning lidar sensor that delivers three dimensional point clouds of designated location points. The imagery sensor may also be configured to have a depth sensitivity and accuracy required by different users. Common ranges include up to four feet and accuracy below ⅛″.

In some embodiments, the vehicle brake monitoring device may include more than one 3D imaging sensor. In some instances the sensors may both be positioned with the same housing but facing different directions so as to increase the number of brake chambers measured at one time. Additionally, the vehicle brake stroke monitoring device may include multiple sensors configured to measure different areas of the vehicle. Such a configuration enables the vehicle brake stroke monitoring device to measure steering axles, power axles, trailer axles, etc.

A preferred digital interface is configured to record and digitize a 3D imagery signal sensed by the associated sensor. The interface card may include a USB external acquisition card that would allow one card to capture the inputs of multiple sensors. Other digital cards may also be used that are specifically configured for processing imagery signals with parameters common among vehicle brakes such as with optimized ranges and resolution designed for the brake stroke measurement application.

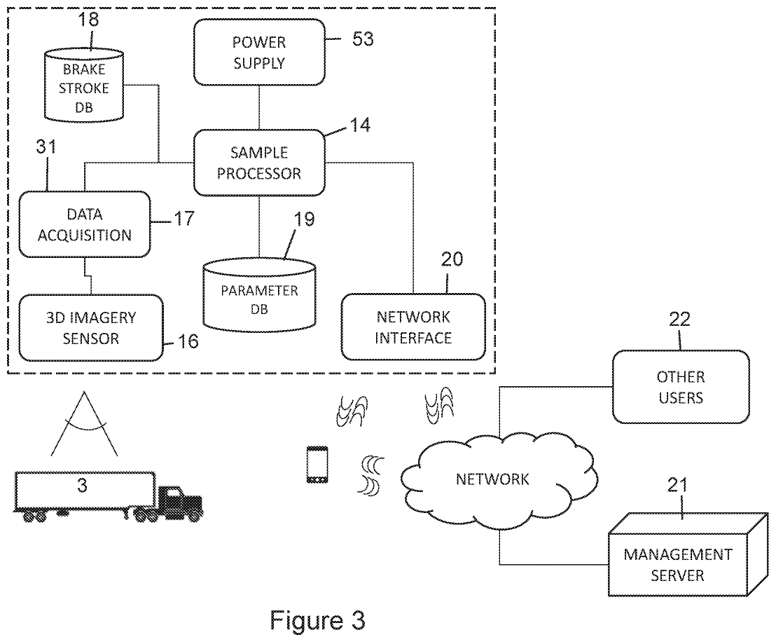

Sample Processor and Database: As shown in FIG. 3, a preferred vehicle brake stroke monitoring system 13 includes a sample processor 14 in a programmed general purpose computer 15 that is configured to capture an image from 3D imagery sensor 16 with a digital data acquisition interface 17 and stored in brake stroke database 18. In processor 14, captured brake stroke data is compared against at least one reference brake stroke measurement that was recorded previously and stored in reference parameter database 19. As a result of this comparison, a display or other output associated with the computer displays the comparison results as an indication of wear and/or remaining life through network interface 20 to management server or a local operator 22 that is used to evaluate the status of the brake stroke associated with the examined vehicle 3.

The sample processor may operate with any operating system or in any programming language. A preferred system is based on a Linux operating system and uses Python and PHP scripting and programming languages. In other embodiments, the sample processor may operate using other types of operating systems and/or processing languages.

The vehicle brake monitoring system of the invention also includes a brake stroke database 18 that is configured to store previous vehicle brake stroke measurements for the examined vehicle or vehicles of comparable make, model, and year, and a reference parameter database 19 that is configured to store the parameters for stroke evaluation and/or classification of such vehicles. Databases 18, 19 may include any type of computer-readable medium (including RAM, ROM, flash memory, magnetic or optical disks, optical memory, or other storage medium) as well as active links through network interface 20 to one or more databases in remote facilities or distributed in a virtual server cloud.

In addition to databases 18, 19 the vehicle brake stroke monitoring system also includes software programming and storage that will convert measured pushrod movement distances from captured digital signals into stroke distance measurements, compare the current distance measurements to one or more reference pushrod stroke measurements, and determine whether to transmit an alert to the operator or just store the data with a display of the measurement information.

The sample processor 14 includes components for evaluating vehicle brake stroke measurements and transmitting alerts. In addition, the sample processor 14 includes components that handle provision, feedback, and database management. It should be appreciated that each of the components may be embodied within machine-readable instructions stored in a memory that are accessible by a processor (e.g. the sample processor 14). In other embodiments, some or all of the components may be implemented in hardware, such as an application specific integrated circuit (“ASIC”). Further, the sample processor 14 may include fewer components, or some of the discussed components may be combined or rearranged.

As discussed in more detail below, the sample processor 14 includes a digital three dimensional imagery interface that is configured to convert digital signals into physical distance measurements that correlate to the travel distance of a vehicle brake pushrod as it applies its brakes. This includes digital imagery samples sensed from examined vehicle 3 within proximity of the vehicle brake stroke monitoring system 13 and brake imagery samples stored as three dimensional point cloud files within the brake stroke database 18. Components are configured to convert digital imagery samples into a feature identification array and convert the imagery samples into physical distance measurements (e.g. a filtered list of viable movement distances). Components also use feature matching to compare the feature travel distance to the brake stroke measurement database to accordingly detect dangerous brake conditions.

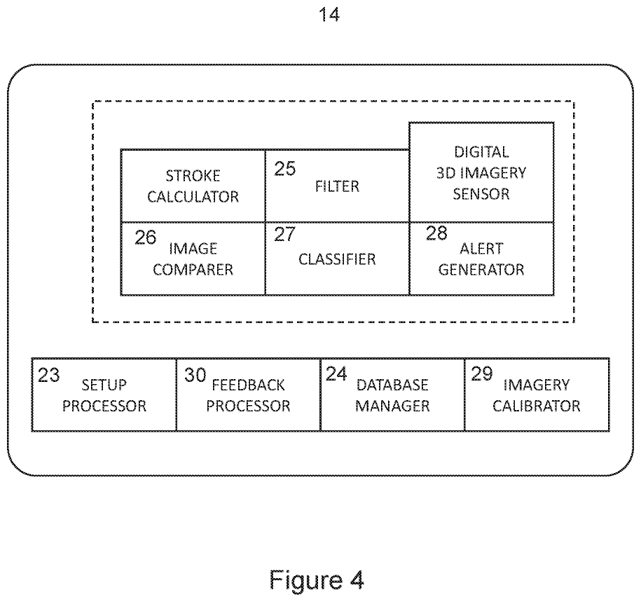

As shown in FIG. 4, the sample processor 14 includes a setup processor 23 that evaluates and stores vehicle brake stroke measurements. The setup processor 23 is configured to prompt or otherwise receive user and/or manufacturer parameters and apply those parameters for the evaluation and alert generation related to brake condition. The setup processor 23 may, for example, provide a user interface or web form that enables a user to specify parameters. Alternatively, a user may use the application to enter parameters, which are transmitted to the setup processor 23 for configuration.

The sample processor 14 is configured to use a database manager 24 to access the brake stroke measurement database 18 and acquire brake stroke measurement records and/or brake stroke parameter database 19 for brake stroke reference parameters. Brake stroke measurements are physical measurement samples of vehicle stroke distances while braking. The stroke measurement samples may be stored as a polygon file, a point cloud file, or simple distance measurements file, or any other digital file. Each measurement is labeled or otherwise associated with make, model, class, brand, etc. of the braking system that generated the stroke travel sample. In some instances, the make, model, class, etc. may be stored as metadata of the point cloud file.

The sample processor 14 includes a filter 14 to convert a digital stroke distance imagery samples into viable stroke measurements. The digital card may have digitized the digital imagery sample from a point cloud sensed by the sensor 16 using, for example, a change detection algorithm such as feature detection and extraction, speeded-up robust features (SURF), etc.

The sample processor 14 includes a filter 25 configured to remove outliers from each of the identified features. The filter 25 may use, for example, variable thresholds to identify features, block sizes, etc. The filter may identify multiple brake chamber strokes within one image, for example.

The sample processor 14 includes a composite image processor that is configured to combine each of the images (before and after braking) into a single overlaid image. For example, the composite image processor is configured to combine the images by identifying matching features, as illustrated in FIG. 2. A different approach would include three dimensional point mapping. Adjustable parameters for the composite image processor could include thresholds for feature matching that results in the most likely overlaid composite image.

The sample processor 14 includes a stroke distance comparer 26 that determines a distance difference between the pushrod positions before and after braking as well as determining if that distance is within viable ranges. To determine a distance between the pushrod travel, the sample comparer is configured to determine an equivalent three dimensional distance of travel between features identified as the pushrod before and after braking. Multiple points or features can be used to estimate an average distance of pushrod travel.

The sample processor 14 includes a classifier 27 to identify dangerous brake stroke travel conditions. For each brake stroke travel estimation, the sample classifier 27 is configured to determine a maximum acceptable travel distance. The classifier determines if the difference between the measured travel and the maximum acceptable travel is significant enough to indicate possibly dangerous braking conditions.

False classifications could be produced by unusual background movement that are present during the digital imagery sample (e.g. vehicles moving in the background of the scene, etc.). To reduce false classifications, the classifier 27 is configured via an allowable stroke travel distance measure, for example, based on a user input that provides a minimum and maximum physically possible travel set by a brake chamber manufacturer. Object range thresholds may also be used, for example, to not consider anything moving beyond typical distances to the brake or tire.

Due to variables in imagery sample generation from factors such as different background environments, lighting, and different weather conditions the accuracy of the braking stroke distance calculation can vary. The processor 14 determines which braking stroke travel estimation to use in the comparer 27 by evaluating the range of physically possible travel distances. If those measures are not close enough to the measured travel than the images may not be a good candidate for evaluation. Including historical measurements from that same previous vehicle may also be useful in improving accuracy of measurements.

The sample processor 14 includes an alert generator 28 that creates and transmits alerts responsive to the classifier classifying a brake stroke travel distance sample as indicative of possible dangerous braking conditions. The alert generator 28 creates an alert based on preferences by the user and creates a message specific for the protocol specified by a user. The alert generator 28 may also queue detections and corresponding detection information for transmission to the management server 21. Moreover, the alert generator 28 is configured to store to a data structure each detection incident.

The sample processor 14 includes a background imagery calibrator 29 to adjust brake stroke measurement samples based on environmental characteristics specific to the evaluation environment. For instance, each property and/or location may have unique features that affect measurement images. Some roadway lighting, reflections, landscaping, or sensor location may cause certain images to be attenuated, amplified, shifted, etc. Such changes in image quality may reduce the accuracy of evaluations. The position of the vehicle relative to the imagery sensor will change with each vehicle as it stops over the sensor; in some vehicle configurations, the line of sight from the sensor to the brake chamber may be obstructed or partially obstructed.

A common challenge for vision-based vehicle brake evaluation is that vehicles oftentimes operate in environments with different amounts and types of background lighting. For example, a vehicle brake monitoring device operating at night may require flash lighting while a device operating in bright daylight may need autoexposure correction that does not make the components under the vehicle too dark to image. The exemplified sample processor 14 may incorporate automatic exposure and illumination controls to optimize imagery acquisition. The exemplified vehicle brake monitoring system 13 is configured to consider lighting and exposure in an image by using for example brightness histograms or other commonly used photography elements.

The sample processor 14 may include a feedback processor 30 to refine evaluations based on false-positive evaluations and false-negatives. For example, after the alert generator 28 transmits an alert, a user receiving that alert by audible or visual methods may provide feedback input that there are, in fact, no dangerous braking conditions found after human inspection. The user may provide the feedback via, for example, the user interface or a voice recognition input. After receiving such user feedback, the feedback processor 30 is configured to adjust the feature matching thresholds used in issuing alerts in future vehicle brake evaluations to provide more accurate measurements and classifications. As the number of measurements and feedback responses increase, the detection and alert system will get more accurate and adjust its responses accordingly.

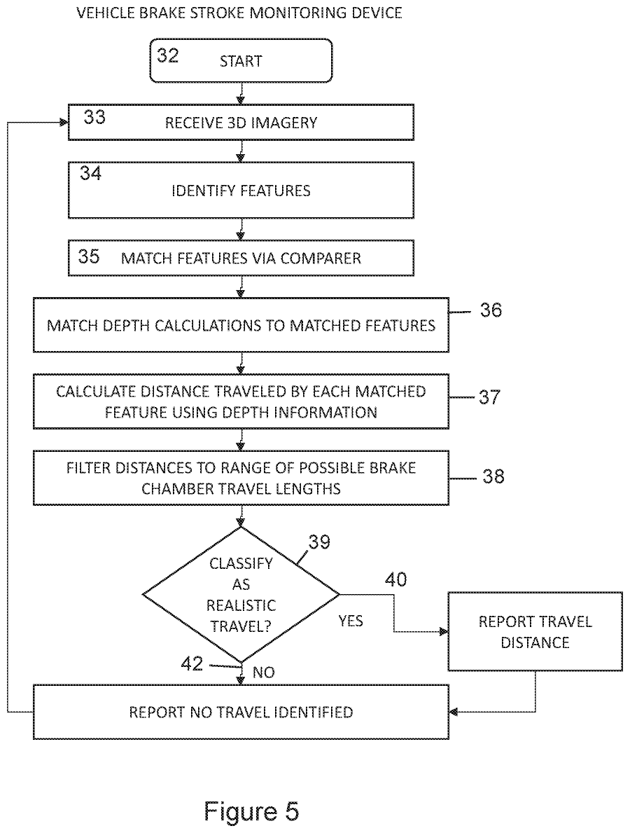

FIG. 5 is a flow chart showing an exemplary procedure to establish baseline vehicle brake imagery, according to a preferred embodiment of the present disclosure. Although the procedure is described with reference to the flow diagram, it should be appreciated that many other methods of performing the steps associated with the procedure may be used. For example, the order of many of the blocks may be changed, certain blocks may be combined with other blocks, and many of the blocks described are optional. Further, the actions described in the procedure may be performed among multiple devices including, for example the imagery processor, the filter, the composite image processor (collectively the sample processor), the three dimensional imaging sensors( ), and/or the digital interface card.

As noted above, the preferred system according to the present invention is configured to enable a user to provision, calibrate, record vehicle brake imagery samples, receive alerts, and communicate with the vehicle brake monitoring devices. In addition, the system may include features that use alert information to provide a more comprehensive alert. For example, the system may receive an indication of an alert including a location of the vehicle brake monitoring device that makes the alert and/or a detailed description of the vehicle and of a possible dangerous braking condition.

The management server 21 is configured to manage the distribution of vehicle brake monitoring devices and brake imagery samples. As previously discussed, the management server 21 is configured to receive brake image samples 31 from devices generating images of a braking event. The management server 21 is also configured to compile braking event evaluations and make these evaluations available to maintenance personnel, vehicle operators, and law enforcement for example in report form. In some instances, different users provide different types of geographic information, which is resolved by the management server 21 into the appropriate location of vehicles recorded in that particular location. The management server 21 and/or the application may enable a user to filter the data for specific locations, time periods, vehicle class, vehicle brand, etc.

FIG. 5 also shows how to analyze the determination points and questions for analyzing three dimensional imagery of the brakes of a vehicle under inspection. As shown, the sequence is initialized 32 and begins to receive digital 3D imagery 33, identifies key surface features 34 from that imagery, matches the key features with a comparator in 35, matches the depth calculations to the matched features in 36, calculates the distances traveled by each match feature using the depth information in 37, filters the calculated distances to those within a range of possible brake pushrod travel lengths in 38 and then must make a determination of whether the filtered distances can qualify as realistic distances for a brake pushrod in 39. If yes (40), the system reports the travel distance to an output system to management server 21 or users 22, resets, and then returns 41 to receive new imagery. If no (42), the system resets and returns to gather new imagery.

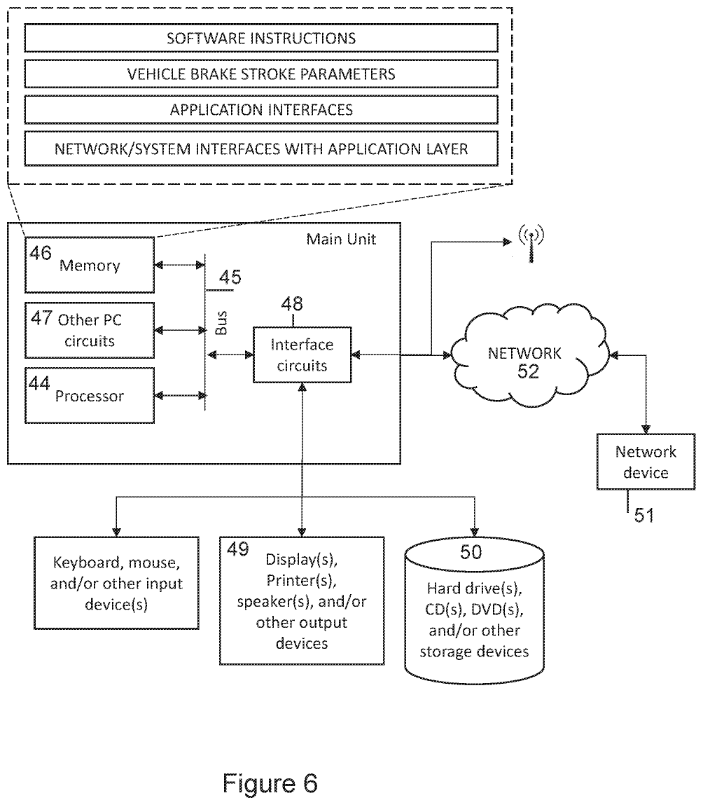

An exemplary system like that of FIG. 3 is illustrated in a different way in FIG. 6. Main unit 43 preferably includes one or more processors 44 communicatively coupled by an address/data bus 45 to one or more memory devices 46, other computer circuitry 47, and one or more interface circuits 48. Memory devices 46 store software instructions, vehicle braking measurement records, user interface features, permissions, and protocols.

Interface circuit 48 may be implemented using any suitable interface standard, such as an Ethernet interface and/or a Universal Serial Bus (“USB”) interface. One or more displays, printers, speakers, and/or other output devices 49 may also be connected to main unit 43 via interface circuits 48. One or more storage devices 50 may also be connected to main unit 43 via the interface circuits 48. The computing device may also exchange data with other network devices 51 via a connection to a network 52 (e.g., the internet). Interface circuits 48 may also include a wireless transceiver that communicates with an active transceiver on network 52. Access to the devices can be controlled by appropriate security software or security measures on management server 21.

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

Reports and Alerts: The example sample processor is configured to transmit different types of reports and alerts based on, for example, preference of a user, manufacturer, etc. Depending on the type of report or alert, the sample processor may create a message that includes a time of evaluation, a determined brake condition, and/or an identifier of the vehicle. The sample processor formats the message based on the type of alert specified by the user. For example, the sample processor may configure a message for Simple Mail Transfer Protocol (“SMTP”), Short Message Service (“SMS”), File Transfer Protocol (“FTP”), Hyper Text Transfer Protocol (“HTTP”), Secure Shell Transport Layer Protocol (“SSH”), etc. After formatting the appropriate message, the example sample processor transmits the message.

In some embodiments, the sample processor may be configured to queue reports until specified times. In these embodiments, the sample processor transmits the reports at the specified time. Additionally, or alternatively, the sample processor may be configured to provide different contexts of evaluations and/or classifications. For example, text messages may be transmitted to the user device as soon as possible after detection of dangerous braking conditions. However, FTP-based reports are transmitted to the management server every few days, weeks, etc. In this example, the text message may include specific vehicles where the dangerous conditions were detected. In contrast, the FTP-based message may include longer term trends, predictions about future conditions, and nature of changes detected.

Network and Interface: As mentioned, the sample processor is configured to receive user input and transmit alerts and other data associated with alerts. The vehicle brake monitoring system includes a network interface that facilitates communication between the sample processor and devices external to the device. The network interface may include a wired and/or wireless interface to connect to, for example, the network and/or the user device. For instance, the network interface may include an Ethernet interface to enable the vehicle brake monitoring system to connect to a router and/or network gateway. The network interface may also include a WLAN interface to enable the vehicle brake monitoring device to communicatively couple to a wireless router and/or a wireless gateway. The network interface may further include a cellular interface to enable the vehicle brake monitoring device to communicatively couple to a cellular network, for example. The network interface may also include functionality to enable powerline communications. The network interface may moreover include a Bluetooth interface (and/or a USB interface, a Near Field Communication (“NFC”) interface, etc.) to enable, for example, the user device to communicate directly with the vehicle brake monitoring system without the use of the network.

Power Supply: The example vehicle brake monitoring system also includes a power supply 53 to provide power to, for example, the imaging sensor, the digital interface card, the sample processor, the database server, and/or the network interface. The power supply may include a battery, and more specifically, a lithium ion battery. The power supply 53 may also include a voltage transformer to convert an AC signal from, for example, a wall outlet, into a regulated DC voltage. In some embodiments, the power supply 53 may include both a transformer and a battery, which is used when power from the wall outlet is not available. In further embodiments, the power supply 53 may include one or more solar panels, thereby enabling the vehicle brake monitoring device to operate in remote locations.

It should be understood that various changes and modifications to the example embodiments described herein will be apparent to those skilled in the art. Such changes and modifications can be made without departing from the spirit and scope of the present subject matter and without diminishing its intended advantages. For example, improvements could be made by including measurements from multiple sensors, or moving the vehicle and averaging multiple measurements. It is therefore intended that such changes and modifications be covered by the appended claims.

What is claimed is:

1. A process for automatically evaluating brake pushrod stroke length in a braking system of a vehicle, said process comprising:
(a) receiving a series of three-dimensional images of a vehicle brake pushrod during operation from one or more imagery sensors;
(b) recording at least a first three-dimensional image of the brake pushrod with the brake applied and at least a second three-dimensional image of the brake pushrod with the brake released;
(c) converting the differences in the pushrod location between the first image and the second image into a calculated pushrod travel measurement representative of a physical distance;
(d) comparing the calculated pushrod travel measurement to data stored in a database of measurements from vehicle brakes exhibiting one or more of defects, excess wear, or problems; and
(e) transmitting to an operator an alert of any problems that may exist with the sampled vehicle brake.

2. A process according to claim 1 wherein said series of three-dimensional images are obtained by sensors located at a distance from said vehicle.

3. A process according to claim 2 wherein said one or more three dimensional images are received by sensors located beneath the vehicle front wheels, the vehicle rear wheels, or both the vehicle front and rear wheels.

4. A process according to claim 3 wherein one of the one or more pushrod travel distance measurements in said database corresponds to pushrod travel distances from the same or similar vehicles at a previous time when all of the brakes on such vehicles were known to be essentially free of wear, properly adjusted, and defect-free.

5. A process according to claim 5 wherein the transmitting comprises sending an alert to said operator if there exists a significant deviation from the previously recorded measurements for said vehicle and which may indicate problems with at least one of the brakes of said vehicle.

6. A process according to claim 1 wherein said one or more imagery sensors are located under a vehicle under inspection and record said at least a first three-dimensional image.

7. A process according to claim 1 wherein said alert is based on a measured brake stroke distance that represents a distance that indicates a problem.

8. A process according to claim 1 wherein said alert is based on a measured pushrod travel measurement that represents a pattern indicating differences in relative measurements from different wheels that indicate an imbalance.
